(19) United States
(12) Patent Application Publication
(10) Pub. No.: US 2023/0035501 A1
(43) Pub. Date: Feb. 2, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Aichi-ken (JP)

(72) Inventor: Go TEJIMA, Toyota-shi (JP)

(21) Appl. No.: 17/853,830

(22) Filed: Jun. 29, 2022

(30) Foreign Application Priority Data
Jul. 27, 2021 (JP) 2021-122149

(51) Int. Cl. G06Q 30/02; G06Q 50/06; G06N 3/08

(52) U.S. Cl. CPC G06Q 30/0206; G06Q 30/0284; G06Q 50/06; G06N 3/08

(57) ABSTRACT

An information processing device includes a prediction section and a price determination section. The prediction section predicts demand for hydrogen at a hydrogen station by using a demand prediction model that is a trained model generated beforehand through machine learning, the demand prediction model receiving at least a behavior pattern of a customer as input and outputting predicted demand for hydrogen. The price determination section determines a price of hydrogen at the hydrogen station, based on the predicted demand for hydrogen.

### CROSS-REFERENCE TO RELATED APPLICATION

This application claims priority to Japanese Patent Application No. 2021-122149 filed on Jul. 27, 2021, incorporated herein by reference in its entirety.

### BACKGROUND

### 1. Technical Field

The disclosure relates to an information processing device, an information processing method, and a storage medium and, more particularly, to an information processing device, an information processing method, and a storage medium that predict demand for hydrogen at a hydrogen station.

### 2. Description of Related Art

Japanese Unexamined Patent Application Publication No. 2016-183768 discloses a method for controlling a hydrogen station reservation system, for the purpose of smoothly filling a vehicle with hydrogen fuel. The method according to JP 2016-183768 A creates a hydrogen filling reservation table in which reservation information, for reserving a date and time when a vehicle of a user will be filled with hydrogen fuel at a hydrogen station, can be input and the input reservation information can be registered. The method according to JP 2016-183768 A calculates a required amount of hydrogen fuel on a date of interest that is a preset number of days after a date read by using the hydrogen filling reservation table in which reservation information from a user is registered.

### SUMMARY

In the technique according to JP 2016-183768 A, since it is not known whether or not a user visits the hydrogen station unless the user makes a reservation, demand for hydrogen cannot be accurately predicted. Moreover, since a hydrogen price at the hydrogen station is not determined according to future demand, there is a possibility that the hydrogen price is not commensurate with demand for hydrogen. Accordingly, it may be difficult to increase profit at the hydrogen station.

The disclosure is to provide an information processing device, an information processing method, and a storage medium that make it possible to efficiently enhance benefit enjoyed by a hydrogen station.

An information processing device according to the disclosure includes: a prediction section that predicts demand for hydrogen at a hydrogen station by using a demand prediction model that is a trained model generated beforehand through machine learning, the demand prediction model receiving at least a behavior pattern of a customer as input and outputting predicted demand for hydrogen; and a determination section that determines a price of hydrogen at the hydrogen station, based on the predicted demand for hydrogen.

An information processing method according to the disclosure includes: predicting demand for hydrogen at a hydrogen station by using a demand prediction model that is a trained model generated beforehand through machine learning, the demand prediction model receiving at least a behavior pattern of a customer as input and outputting predicted demand for hydrogen; and determining a price of hydrogen at the hydrogen station, based on the predicted demand for hydrogen.

A storage medium according to the disclosure stores a program that causes a computer to execute the steps of: predicting demand for hydrogen at a hydrogen station by using a demand prediction model that is a trained model generated beforehand through machine learning, the demand prediction model receiving at least a behavior pattern of a customer as input and outputting predicted demand for hydrogen; and determining a price of hydrogen at the hydrogen station, based on the predicted demand for hydrogen.

Since the disclosure is configured as described above, demand for hydrogen at a hydrogen station can be adjusted, and operation of the hydrogen station can therefore be efficiently performed. Moreover, since the disclosure is configured as described above, revenue at the hydrogen station can be increased. According to the disclosure, benefit enjoyed by a hydrogen station can be efficiently enhanced.

Preferably, the determination section determines the price of hydrogen, based on a ratio between a predicted amount of demand that is the predicted demand for hydrogen at a certain timing at the hydrogen station and a suppliable amount that is an amount of hydrogen suppliable at the certain timing at the hydrogen station.

According to the disclosure thus configured, demand for hydrogen and the price of hydrogen can be adjusted according to a purpose on the hydrogen station side, based on the predicted amount of demand and the suppliable amount.

Preferably, when a first ratio that is a ratio of the predicted amount of demand to the suppliable amount is equal to or more than a predetermined first threshold value and is equal to or less than a predetermined second threshold value that is greater than the first threshold value, the determination section determines the price of hydrogen such that the price becomes higher as the first ratio becomes larger, between a predetermined first price and a predetermined second price.

According to the disclosure thus configured, revenue can be increased according to the predicted amount of demand and the suppliable amount.

Preferably, when the first ratio is less than the first threshold value, the determination section determines the price of hydrogen such that the price is lower than the first price.

According to the disclosure thus configured, demand for hydrogen can be promoted when the predicted amount of demand is too small compared to the suppliable amount.

Preferably, when the first ratio is more than the second threshold value, the determination section determines the price of hydrogen such that the price is higher than the second price.

According to the disclosure thus configured, demand for hydrogen can be restrained when the predicted amount of demand is too large compared to the suppliable amount.

Preferably, the demand prediction model receives the behavior pattern and a price of hydrogen at the hydrogen station as input, and the determination section determines the price of hydrogen, according to the price of hydrogen input into the demand prediction model and a predicted amount of demand that is the demand for hydrogen acquired by using the demand prediction model.

According to the disclosure thus configured, an increase in revenue can be more reliably achieved.

Preferably, a notification section that notifies the determined price of hydrogen to the customer is further included.

According to the disclosure thus configured, customer convenience can be enhanced.

Preferably, a training section that trains the demand prediction model through machine learning is further included, and the training section continues to train the demand prediction model, depending on a difference between the demand predicted by the prediction section and actual demand.

According to the disclosure thus configured, since demand for hydrogen changing due to the determined price of hydrogen can be predicted, accuracy of prediction of demand for hydrogen can be further enhanced.

According to the disclosure, the information processing device, the information processing method, and the storage medium can be provided that make it possible to efficiently enhance benefit enjoyed by a hydrogen station.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an information processing system according to a first embodiment;

FIG. 2 shows a hardware configuration of an information processing device according to the first embodiment;

FIG. 3 is a block diagram showing a configuration of the information processing device according to the first embodiment;

FIG. 4 illustrates input data that is input into a demand prediction model according to the first embodiment;

FIG. 5 illustrates features in the input data according to the first embodiment;

FIG. 6 illustrates a customer behavior pattern according to the first embodiment;

FIG. 7 illustrates a customer behavior pattern according to the first embodiment;

FIG. 8 illustrates a customer behavior pattern according to the first embodiment;

FIG. 9 illustrates a customer behavior pattern according to the first embodiment;

FIG. 10 illustrates output data that is output from the demand prediction model according to the first embodiment;

FIG. 11 illustrates demand predictions acquired by a demand prediction section according to the first embodiment;

FIG. 12 is a flowchart showing an information processing method that is executed by the information processing device according to the first embodiment;

FIG. 13 is a flowchart showing the information processing method that is executed by the information processing device according to the first embodiment;

FIG. 14 is a block diagram showing a configuration of an information processing device according to a second embodiment;

FIG. 15 is a diagram for describing an example of a price determination method by a price determination section according to the second embodiment;

FIG. 16 illustrates actual demand for hydrogen when a hydrogen price is determined by the price determination section according to the second embodiment;

FIG. 17 illustrates a hydrogen price notification according to the second embodiment;

FIG. 18 is a flowchart showing an information processing method that is executed by the information processing device according to the second embodiment;

FIG. 19 is a block diagram showing a configuration of an information processing device according to a third embodiment;

FIG. 20 illustrates features in input data according to the third embodiment;

FIG. 21 is a flowchart showing an information processing method that is executed by the information processing device according to the third embodiment;

FIG. 22 is a block diagram showing a configuration of an information processing device according to a fourth embodiment;

FIG. 23 is a flowchart showing an information processing method that is executed by the information processing device according to the fourth embodiment; and

FIG. 24 is a diagram for describing a price determination method by a price determination section according to the fourth embodiment.

### DETAILED DESCRIPTION OF EMBODIMENTS

### First Embodiment

Hereinafter, embodiments of the disclosure are described with reference to the drawings. In order to clarify the description, omissions and simplifications are made as appropriate in the following description and drawings. Moreover, throughout the drawings, the same elements are denoted by the same signs, and an overlapping description is omitted as necessary.

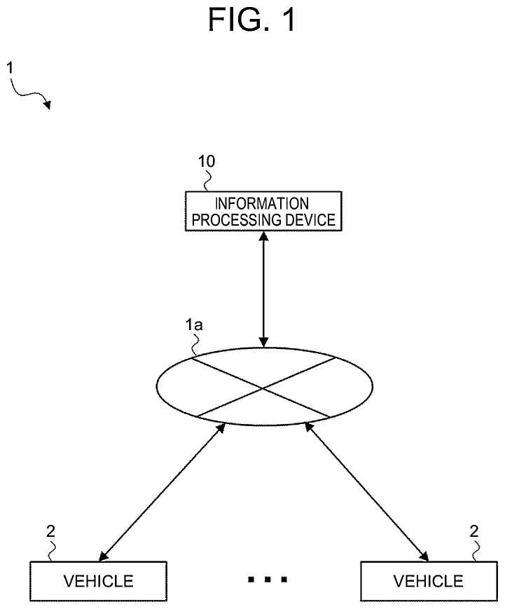

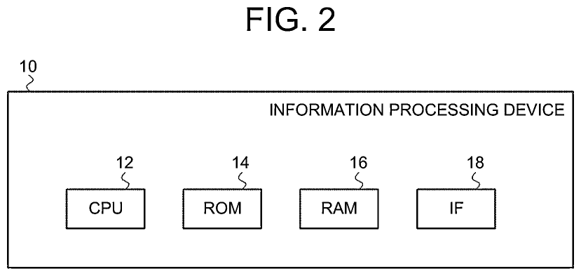

FIG. 1 shows an information processing system 1 according to a first embodiment. The information processing system 1 includes a plurality of vehicles 2 and an information processing device 10. Each vehicle 2 is a vehicle that uses hydrogen for fuel (for example, a fuel cell electric vehicle). The information processing device 10 is, for example, a computer such as a server. The information processing device 10 and each vehicle 2 can be communicably connected through a network 1a that is a wireless network or the like. Each vehicle 2 may have a hardware configuration of the information processing device 10, which will be described later by using FIG. 2.

The information processing device 10 predicts demand for hydrogen at a hydrogen station that supplies hydrogen to a vehicle 2. Specifically, the information processing device 10 predicts demand for hydrogen by using a machine learning algorithm such as deep learning, a neural network, or a recurrent neural network. The information processing device 10 can be implemented by one or more computers. The information processing device 10 may be implemented by a cloud system. Accordingly, physical implementation of the information processing device 10 is not limited to implementation by a single device.

FIG. 2 shows a hardware configuration of the information processing device 10 according to the first embodiment. The information processing device 10 includes, as main hardware components, a central processing unit (CPU) 12, a read-only memory (ROM) 14, a random-access memory (RAM) 16, and an interface part (IF) 18. The CPU 12, the ROM 14, the RAM 16, and the interface part 18 are mutually connected through a data bus or the like.

The CPU 12 includes a function as an arithmetic operation device (processing device or a processor) that performs control processing, arithmetic operation processing, and the like. Note that the arithmetic operation device may be implemented by a device dedicated for machine learning such as a neural network processing unit (NPU) or a graphics processing unit (GPU). The ROM 14 includes a function as a storage that stores a control program, an arithmetic operation program, and the like to be executed by the CPU 12 (arithmetic operation device). The RAM 16 includes a function as a memory that transitorily stores processed data and the like. The interface part 18 includes a function as a communication device that receives a signal as input from and outputs a signal to outside by wire or wirelessly. Moreover, the interface part 18 includes a function as a user interface that performs processing for receiving a data entering operation made by a user and displaying information to the user. The interface part 18 may display a result of demand prediction.

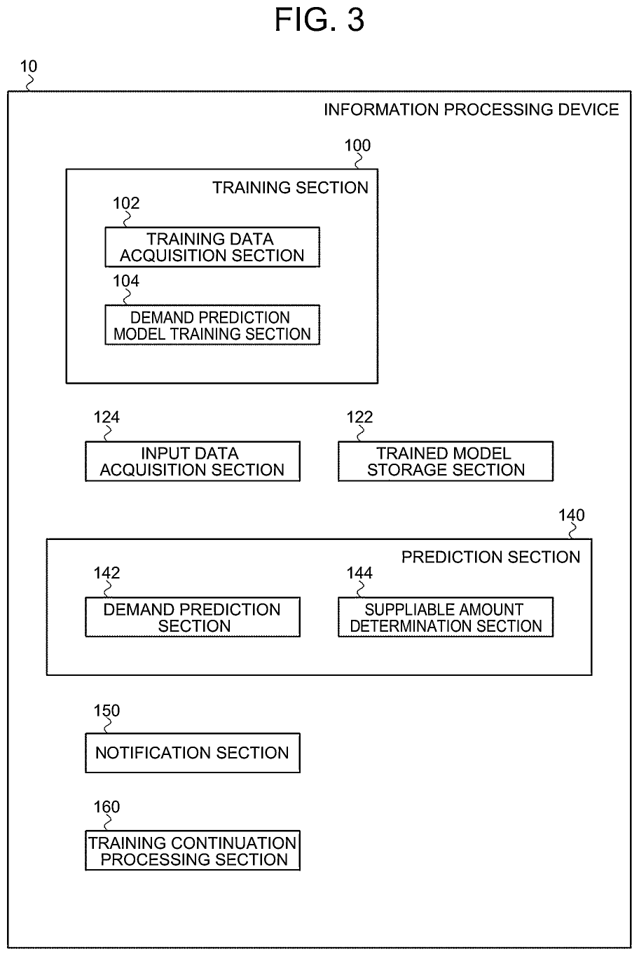

FIG. 3 is a block diagram showing a configuration of the information processing device 10 according to the first embodiment. The information processing device 10 according to the first embodiment includes a training section 100, a trained model storage section 122, an input data acquisition section 124 (acquisition section), a prediction section 140, a notification section 150, and a training continuation processing section 160. The training section 100 includes a training data acquisition section 102 and a demand prediction model training section 104. The prediction section 140 includes a demand prediction section 142 and a suppliable amount determination section 144.

Such constituent elements can be implemented, for example, by the CPU 12 (arithmetic operation device) executing a program stored in the ROM 14 (storage device). Each constituent element may be implemented by storing a required program in an arbitrary non-volatile recording medium and installing the program as necessary. Note that implementation of each constituent element is not limited to implementation by software as described above, and each constituent element may be implemented by hardware such as some circuit element or the like. One or more of the constituent elements may be individually implemented by physically separate hardware pieces. For example, the training section 100 may be implemented by a hardware piece separately from the other constituent elements. Such configurations also hold true for other embodiments, which will be described later.

The training section 100 trains a demand prediction model for predicting demand for hydrogen at a hydrogen station, by using the machine learning algorithm. In other words, the training section 100 performs machine learning to build the demand prediction model. The training section 100 performs machine learning such that demand for hydrogen is predicted by using at least a behavior pattern of a customer. Accordingly, the demand prediction model receives, as input, input data including at least customer behavior pattern information indicating a behavior pattern of a customer, and outputs demand (a predicted amount of demand for hydrogen (predicted amount of demand)) at each hydrogen station. The predicted amount of demand indicates an amount of demand for hydrogen after a predetermined time period (for example, after one day, two days, a week, a month, or the like).

The training data acquisition section 102 acquires training data that is a pair of input data and correct data. The input data includes customer behavior pattern information and regional information. Here, the input data is time-series data in which the value of a corresponding feature changes with passage of time.

The customer behavior pattern information indicates a behavior pattern of each of a plurality of customers. Accordingly, the customer behavior pattern information can be generated with respect to each of the plurality of customers. For example, the customer behavior pattern information can be acquired from a vehicle 2 owned by a customer via the network 1a. The customer behavior pattern information indicates, for example, a timing when the customer fills the vehicle 2 with hydrogen (frequency of filling), a hydrogen station visited by the customer, and a filling amount when the vehicle 2 is filled with hydrogen. Details will be described later.

The regional information is information different from a behavior pattern of a customer, and indicates various information in a region. For example, the regional information indicates weather, information related to a hydrogen station in a corresponding region, information related to an event in the corresponding region, and the like. Details will be described later.

The correct data corresponds to output data at an operation stage (inference stage, prediction stage). Here, as described above, the output data indicates an amount of demand for hydrogen after a predetermined time period at each hydrogen station. Accordingly, the correct data corresponds to an actual amount of demand for hydrogen at a certain timing at each hydrogen station.

The demand prediction model training section 104 performs processing of training the demand prediction model by using the acquired training data. For example, the demand prediction model can be implemented based on the machine learning algorithm such as deep learning, a neural network, or a recurrent neural network. The demand prediction model training section 104 trains the demand prediction model such that the demand prediction model receives the input data as input and outputs the correct data. The demand prediction model training section 104 may generate the demand prediction model by using, for data for learning, training data in a certain time period (for example, several months). The demand prediction model training section 104 may adjust a parameter (a weight or the like) of the demand prediction model by using, for data for evaluation, training data in a predetermined time period (for example, several weeks) after the certain time period. The demand prediction model training section 104 may extract an important feature from input data by using an autoencoder.

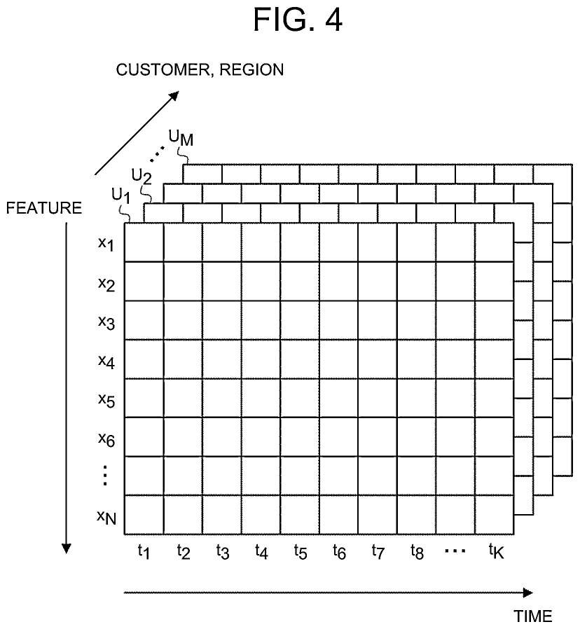

FIG. 4 illustrates input data that is input into the demand prediction model according to the first embodiment. As illustrated in FIG. 4, the input data is time-series data on a plurality of features. The example in FIG. 4 shows the input data, with the horizontal axis being a time axis, and the vertical axis representing time-series features. In other words, each of features x₁, x₂, x₃, . . . , x_{N} is time-series data. N is the number of features. The features may be sampled, for example, in each predetermined time period Δt. In such a case, each of time intervals between t₁, t₂, t₃, . . . , tₖ on the horizontal axis in FIG. 4 is Δt. Moreover, Δt may be, for example, 30 minutes, an hour, six hours, or one day (24 hours). The sampling cycle Δt can be set as appropriate, depending on desired fineness of demand predictions on a time series. For example, the sampling cycle Δt in a case where a demand prediction is desired to be obtained every several hours may be shorter than the sampling cycle Δt in a case where a demand prediction is desired to be obtained every several days.

The input data can be generated for each customer and each region. For example, input data (customer behavior pattern information) U₁, U₂, U₃ are generated for a customer #1, a customer #2, a customer #3, respectively. For example, input data (regional information) Uₘ₊₁, Uₘ₊₂, Uₘ₊₃ are generated for a region #1, a region #2, a region #3, respectively. A set of such input data U₁ to U_{M} is input as input data into the demand prediction model.

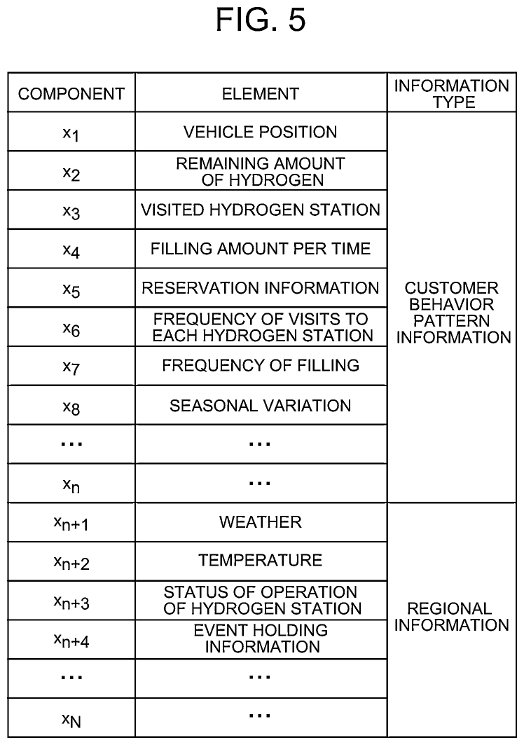

FIG. 5 illustrates features in the input data according to the first embodiment. Note that the features illustrated in FIG. 5 are only examples, and other various features are possible. Here, components x₁ to xₙ in FIG. 5 indicate features in the customer behavior pattern information. Components xₙ₊₁ to x_{N} indicate features in the regional information. The values of xₙ₊₁ to x_{N} may be zero in the customer behavior pattern information. Similarly, the values of x₁ to xₙ may be zero in the regional information.

Regarding the features included in the customer behavior pattern information, in the example shown in FIG. 5, the component x₁ indicates the position of a vehicle 2 of a corresponding customer, at corresponding time (time of sampling). The component x₂ indicates a remaining amount of hydrogen in the vehicle 2 of the corresponding customer, at the corresponding time (time of sampling). The remaining amount of hydrogen may be a state of charge (SOC).

The component x₃ indicates a hydrogen station visited at the corresponding time (time of sampling) in order for the corresponding customer to fill the vehicle 2 with hydrogen. The component value of x₃ is predetermined for each hydrogen station, such as “hydrogen station A: x₃=1”, “hydrogen station B: x₃=2”, and so on. The component value of x₃ may be zero when the customer does not visit any hydrogen station at the corresponding time (time of sampling).

The component x₄ indicates a filling amount of hydrogen with which the vehicle 2 of the corresponding customer is filled. The filling amount may be an increase in the state of charge when the vehicle 2 is filled with hydrogen. The component value of x₄ may be zero when the customer does not fill the vehicle 2 with hydrogen at the corresponding time (time of sampling). The component x₅ indicates reservation information related to the corresponding customer. The reservation information indicates whether or not a reservation for the customer to visit a hydrogen station to fill the vehicle 2 with hydrogen has been made in advance at the corresponding time (time of sampling). The component value of x₅ is predetermined for each of presence and absence of a reservation, such as “reservation is present: x₅=1”, “reservation is absent: x₅=0”.

The component x₆ indicates a frequency of visits to each hydrogen station made by the corresponding customer. The component x₇ indicates a frequency of filling with which the corresponding customer fills the vehicle 2 with hydrogen. The component x₈ indicates seasonal variation in the behavior pattern of the corresponding customer. Note that x₆ to x₈ do not need to be time-series data and can be derived from the customer behavior pattern information, which will be described later. Accordingly, x₆ to x₈ do not need to be included as features.

Regarding the features included in the regional information, in the example shown in FIG. 5, the component xₙ₊₁ indicates weather in a corresponding region at the corresponding time (time of sampling). The component value of xₙ₊₁ is predetermined for each weather condition (fine weather, rainy weather, and the like), such as “fine: xₙ₊₁=1”, “rainy: xₙ₊₁=2”, and so on. The component xₙ₊₂ indicates a temperature in the corresponding region at the corresponding time (time of sampling). The component xₙ₊₃ indicates a status of operation of a hydrogen station installed in the corresponding region, at the corresponding time (time of sampling). The status of operation indicates whether or not the corresponding hydrogen station is operating, for example, on a day-of-week basis and on a time-period-of-day basis. The component xₙ₊₄ indicates event holding information in the corresponding region. The event holding information may indicate the type of an event held at the corresponding time (time of sampling) and the size (capacity or the like) of the event.

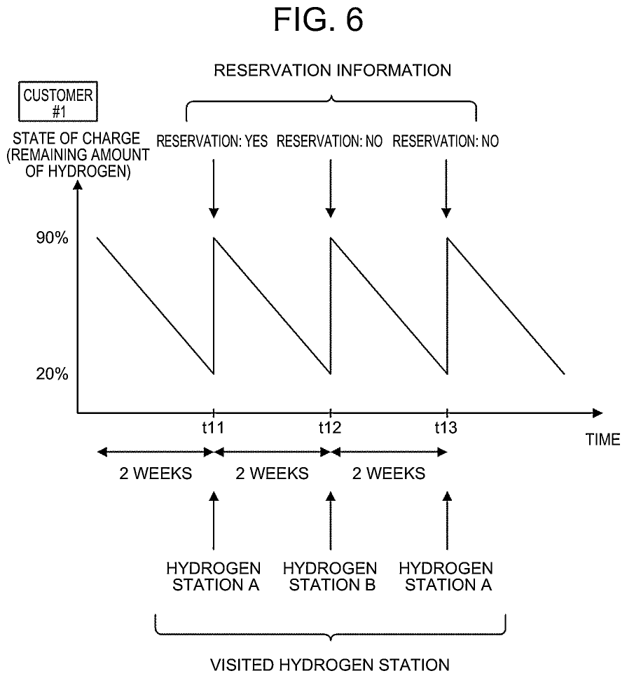

FIGS. 6 to 9 illustrate customer behavior patterns according to the first embodiment. Each of the customer behavior patterns illustrated in FIGS. 6 to 9 is shown as a graph, with the horizontal axis representing time, and the vertical axis representing the state of hydrogen charge (remaining amount of hydrogen) of a vehicle 2 of a corresponding customer. Accordingly, the customer behavior patterns are time-series data. Note that FIGS. 6 to 9 show changes in the state of hydrogen charge over time. Accordingly, the changes in the state of hydrogen charge over time in FIGS. 6 to 9 correspond to the feature “remaining amount of hydrogen” illustrated in FIG. 5. Note that a customer behavior pattern may indicate changes in the position of the corresponding vehicle 2 over time. In such a case, the changes in the position of the vehicle 2 over time correspond to the feature “vehicle position” illustrated in FIG. 5.

FIG. 6 illustrates a customer behavior pattern of the customer #1. In the customer behavior pattern illustrated in FIG. 6, when approximately two weeks have passed since the state of hydrogen charge of the vehicle 2 of the customer #1 was 90%, the state of charge decreases to 20%. When the state of charge decreases to 20% for a first time (time t11), the customer #1 visits a hydrogen station A and fills the vehicle 2 with so much hydrogen as to increase the state of charge from 20% to 90%, that is, with an amount of hydrogen corresponding to a size of state of charge of 70%. At the time, the customer #1 has a reservation for visiting the hydrogen station A and filling the vehicle 2 with hydrogen.

When the state of charge decreases to 20% for a second time (time t12), the customer #1 visits a hydrogen station B and fills the vehicle 2 with so much hydrogen as to increase the state of charge from 20% to 90%, that is, with an amount of hydrogen corresponding to a size of state of charge of 70%. At the time, the customer #1 does not have a reservation for visiting the hydrogen station B and filling the vehicle 2 with hydrogen. When the state of charge decreases to 20% for a third time (time t13), the customer #1 visits the hydrogen station A and fills the vehicle 2 with so much hydrogen as to increase the state of charge from 20% to 90%, that is, with an amount of hydrogen corresponding to a size of state of charge of 70%. At the time, the customer #1 does not have a reservation for visiting the hydrogen station A and filling the vehicle 2 with hydrogen.

Here, in the customer behavior pattern illustrated in FIG. 6, the facts that the hydrogen station A, the hydrogen station B, and the hydrogen station A are visited at time t11, time t12, and time t13, respectively, correspond to the feature “visited hydrogen station” illustrated in FIG. 5. The facts that the vehicle 2 is filled with an amount of hydrogen corresponding to a size of state of charge of 70% at time t11, time t12, and time t13 correspond to the feature “filling amount per time” illustrated in FIG. 5. The facts of “reservation: yes”, “reservation: no”, and “reservation: no” at time t11, time t12, and time t13, respectively, correspond to the feature “reservation information” illustrated in FIG. 5.

Moreover, the facts that the customer #1 visits the hydrogen station A at time t11 and time t13 and visits the hydrogen station B at time t12 correspond to the feature “frequency of visits to each hydrogen station” illustrated in FIG. 5. The fact that the vehicle 2 is filled with hydrogen every two weeks corresponds to the feature “frequency of filling” illustrated in FIG. 5.

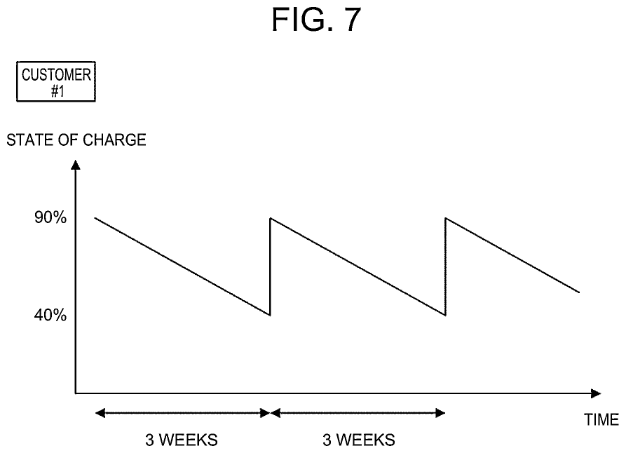

FIG. 7 illustrates a customer behavior pattern of the customer #1 in a different season from a season in FIG. 6. FIG. 6 corresponds to the customer behavior pattern in summer, and FIG. 7 corresponds to the customer behavior pattern in winter. In summer, the customer #1 fills the vehicle 2 with hydrogen when the state of charge decreases to 20%, and in winter, the customer #1 fills the vehicle 2 with hydrogen when the state of charge decreases to 40%. In other words, the customer #1 fills the vehicle 2 with hydrogen in winter earlier than in summer before the state of charge becomes as low as in summer. On the other hand, in summer, the customer #1 fills the vehicle 2 with hydrogen every two weeks, and in winter, the customer #1 fills the vehicle 2 with hydrogen every three weeks. In other words, the frequency of filling by the customer #1 is lower in winter than in summer. As described above, the fact that the behavior pattern varies with the season corresponds to the feature “seasonal variation” illustrated in FIG. 5.

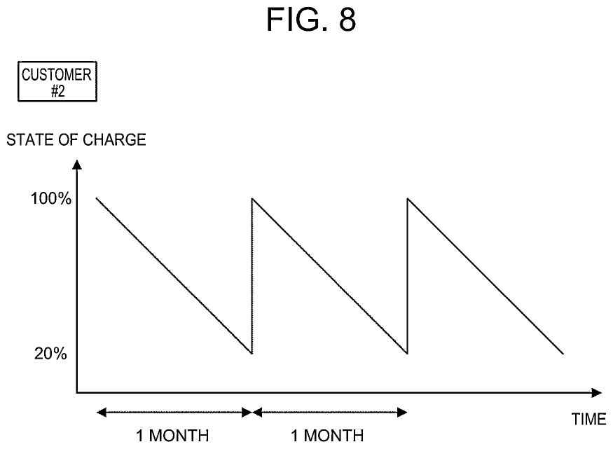

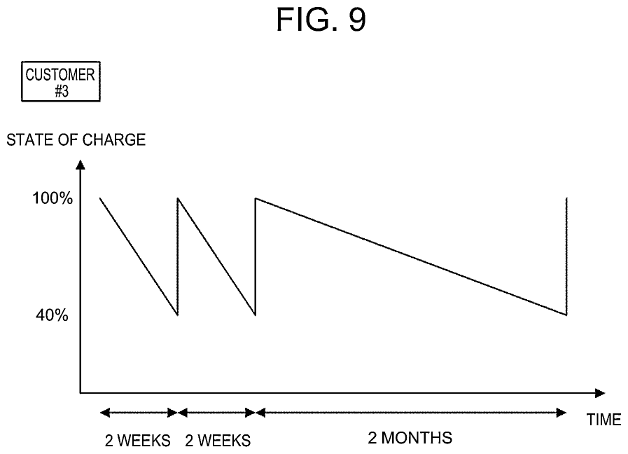

FIG. 8 illustrates a customer behavior pattern of the customer #2. FIG. 9 illustrates a customer behavior pattern of the customer #3. It is assumed that time axes are identical in FIGS. 8 and 9. As illustrated in FIG. 8, the customer #2 fills the vehicle 2 with hydrogen every month. The customer #2 fills the vehicle 2 with hydrogen when the state of charge decreases to 20%. As illustrated in FIG. 9, the customer #3 fills the vehicle 2 with hydrogen every two weeks, but sometimes does not fill the vehicle 2 with hydrogen for two months. The customer #3 fills the vehicle 2 with hydrogen when the state of charge decreases to 40%. In other words, the frequency of filling by the customer #3 at ordinary times is higher than the frequency of filling by the customer #2. Moreover, the customer #3 fills the vehicle 2 with hydrogen earlier than the customer #2 before the state of charge becomes as low as that of the customer #2. The customer #2 fills the vehicle 2 with hydrogen in approximately the same cycle. In contrast, the cycle of filling the vehicle 2 with hydrogen by the customer #3 is not constant because there is a period during which consumption of hydrogen is low. As descried above, behavior patterns can vary depending on customers.

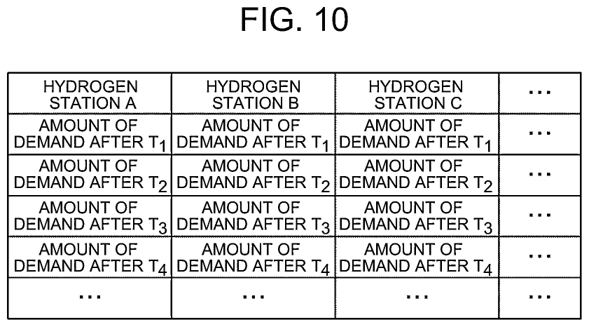

FIG. 10 illustrates output data that is output from the demand prediction model according to the first embodiment. As illustrated in FIG. 10, a predicted amount of demand for hydrogen after a predetermined time period at each hydrogen station is output from the demand prediction model. In the example in FIG. 10, with respect to the hydrogen station A, an amount of demand for hydrogen after a time period T₁, an amount of demand for hydrogen after a time period T₂, an amount of demand for hydrogen after a time period T₃, and an amount of demand for hydrogen after a time period T₄ are output from the demand prediction model. With respect to the hydrogen station B and a hydrogen station C, amounts of demand for hydrogen are also output similarly.

Here, in training data used at a training stage, correct data can correspond to the output data illustrated in FIG. 10. Accordingly, for example, with respect to the hydrogen station A, the correct data may be actual amounts of demand for hydrogen the time period T₁, the time period T₂, the time period T₃, and the time period T₄ after the last time point (corresponding to tₖ in FIG. 4) on a time series of input customer behavior pattern information.

Regarding the customer behavior pattern information at the training stage, information earlier than a prediction target timing (a time point after a predetermined time period such as after the time period T₁), demand for hydrogen at which is predicted, can be used for input data. Regarding the customer behavior pattern information at the operation stage, past information on the time series can be used for input data. This is because it is substantially difficult to acquire future customer behavior pattern information at the operation stage. Regarding the reservation information in the customer behavior pattern information, information up until the prediction target timing (future information) may be used for input data when a reservation is present at the prediction target timing.

Regarding the regional information, information up until the prediction target timing may also be used for input data. In other words, regarding the regional information at the operation stage, future information can also be used for input data. Here, in the example in FIG. 5, “weather” and “temperature” can be acquired from a weather forecast. “Status of operation of hydrogen station” can be acquired from a schedule of operation of a hydrogen station. “Event holding information” can be acquired from a schedule of events to be held.

When a prediction, at time T₀, of demand after the time period T₁ is to be learned, the demand prediction model training section 104 may train the demand prediction model by using input data for a past time period ΔT going back from T₀ as input, and using an actual amount of demand for hydrogen the time period T₁ after time T₀ for correct data. Note that ΔT corresponds to a time period from t₁ to tₖ on the time axis in FIG. 4. Here, ΔT>Δt. For example, when the sampling cycle is Δt=30 minutes, it may be set that ΔT=6 hours, and input data for past six hours from T₀ may be input to the demand prediction model. When the sampling cycle is Δt=24 hours, it may be set that ΔT=1 month, and input data for past one month from T₀ may be input to the demand prediction model. Alternatively, when the sampling cycle is Δt=24 hours, it may be set that ΔT=1 year, and input data for past one year from T₀ may be input to the demand prediction model.

When training of the demand prediction model is finished, the demand prediction model training section 104 outputs the trained demand prediction model to the trained model storage section 122. Thus, the trained model storage section 122 stores the demand prediction model that is a trained model generated beforehand through machine learning. The demand prediction model that is a trained model receives input data that is time-series data including features as illustrated in FIGS. 4 and 5 as input, and outputs predicted demand for hydrogen at each hydrogen station as illustrated in FIG. 10.

The training section 100 may continue to train the demand prediction model, depending on a difference between demand predicted by the prediction section 140, which will be described later, and actual demand. Details will be described later.

The input data acquisition section 124 acquires input data as described above, at the operation stage. Here, the input data acquisition section 124 acquires at least a customer behavior pattern (customer behavior pattern information) as input data.

The input data acquisition section 124 acquires the customer behavior pattern information that is input data from each vehicle 2 via the network 1a by using the interface part 18. Moreover, the input data acquisition section 124 acquires regional information as input data. For example, the input data acquisition section 124 acquires the customer behavior pattern information that is time-series data between a current point time and a past time point a predetermined time period earlier than the current point time. For example, the input data acquisition section 124 acquires the regional information that is time-series data between the time point the predetermined time period earlier than the current time point and a future time point until which the information can be acquired.

The prediction section 140 predicts demand for hydrogen at at least one hydrogen station by using the demand prediction model stored in the trained model storage section 122. In other words, the prediction section 140 predicts demand for hydrogen at at least one hydrogen station by using the demand prediction model that receives at least customer behavior pattern information as input and outputs predicted demand for hydrogen.

The demand prediction section 142 inputs the input data acquired by the input data acquisition section 124 into the demand prediction model stored in the trained model storage section 122. Thus, the demand prediction model outputs a predicted amount of demand for hydrogen at each hydrogen station as illustrated in FIG. 10. Thus, the demand prediction section 142 predicts an amount of demand for hydrogen at each hydrogen station.

As described above, the demand prediction section 142 (prediction section 140) is configured to predict demand for hydrogen at at least one hydrogen station by using the demand prediction model that receives at least customer behavior pattern information as input and outputs predicted demand for hydrogen. Thus, the information processing device 10 according to the first embodiment can predict demand for hydrogen at a hydrogen station with high accuracy. In other words, since a configuration is made such that demand for hydrogen is predicted by using a behavior pattern of a customer, demand for hydrogen can be predicted even if the customer does not make a reservation for vising a hydrogen station and filling a vehicle with hydrogen. Accordingly, the information processing device 10 according to the first embodiment can predict demand for hydrogen with high accuracy.

Moreover, it can be said that a timing when a customer fills a vehicle with hydrogen is indicated in the customer behavior pattern information that is time-series data, from the features “remaining amount of hydrogen”, “visited hydrogen station”, and “filling amount per time” illustrated in the FIG. 5. In other words, a timing when the component value of the feature “remaining amount of hydrogen” has increased and the component values of the features “visited hydrogen station” and “filling amount per time” have changed corresponds to a timing when a customer has filled a vehicle with hydrogen. Accordingly, the demand prediction section 142 predicts demand for hydrogen by using a timing when a customer fills a vehicle with hydrogen that is indicated in the customer behavior pattern information. Since the demand prediction section 142 (prediction section 140) predicts demand for hydrogen as described above, accuracy of prediction of demand for hydrogen can be enhanced. In other words, the timing when a customer fills a vehicle with hydrogen comes in approximately the same cycle, in many cases. Accordingly, the demand prediction model is adjusted to predict that demand increases at a timing corresponding to such a cycle, whereby accuracy of prediction can be enhanced.

Moreover, as illustrated in FIG. 5, the customer behavior pattern information includes a vehicle position. Accordingly, the demand prediction section 142 predicts demand for hydrogen by using the position of a vehicle of a customer indicated in the customer behavior pattern information. As illustrated in FIG. 5, the customer behavior pattern information includes a remaining amount of hydrogen. Accordingly, the demand prediction section 142 predicts demand for hydrogen by using the remaining amount of hydrogen of a vehicle 2 of a customer indicated in the customer behavior pattern information. Since the demand prediction section 142 (prediction section 140) predicts demand for hydrogen as described above, accuracy of prediction of demand for hydrogen can be enhanced. In other words, it is highly probable that a customer visits a hydrogen station, for example, at a timing when the remaining amount of hydrogen of the vehicle 2 of the customer decreases to an extent that filling is needed (the state of charge of 20% in the examples in FIGS. 6 and 8, and the state of charge of 40% in the examples in FIGS. 7 and 9). Moreover, it is highly probable that the customer visits a hydrogen station close to the position of the vehicle at the timing. Accordingly, the demand prediction model is adjusted to predict that demand at the hydrogen station that is close to the vehicle position at the timing increases at the timing, whereby accuracy of prediction can be enhanced.

As illustrated in FIG. 5, the customer behavior pattern information includes reservation information. Accordingly, the demand prediction section 142 predicts demand for hydrogen by using the reservation information from a customer, indicated in the customer behavior pattern information. Since the demand prediction section 142 (prediction section 140) predicts demand for hydrogen as described above, accuracy of prediction of demand for hydrogen can be enhanced. In other words, it is highly probable that the customer visits a hydrogen station at a timing corresponding to the reservation information. Accordingly, the demand prediction model is adjusted to predict that demand increases at the timing, whereby accuracy of prediction can be enhanced.

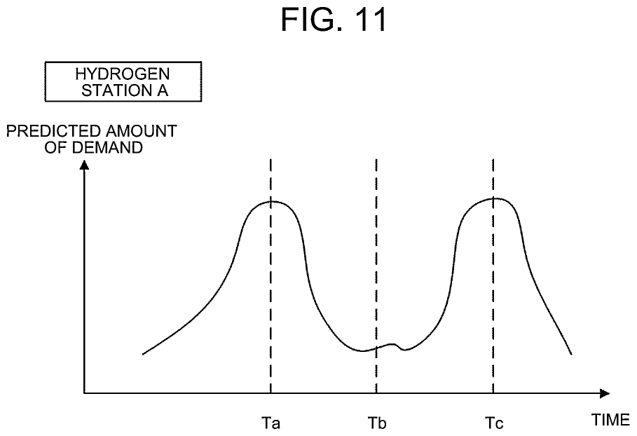

FIG. 11 illustrates demand predictions acquired by the demand prediction section 142 according to the first embodiment. FIG. 11 illustrates predictions of demand at the hydrogen station A. FIG. 11 shows a graph, with the horizontal axis being a time axis, and the vertical axis representing predicted amounts of demand Here, predicted amounts of demand at a plurality of timings (after T₁, after T₂, after T₃, after T₄, . . . ) are output from the demand prediction model, as illustrated in FIG. 10. Accordingly, the graph illustrated in FIG. 11 can be generated by plotting the predicted amounts of demand at the plurality of timings.

In the demand predictions illustrated in FIG. 11, demand increases at a timing corresponding to Ta. Demand decreases at a timing corresponding to Tb. Demand increases at a timing corresponding to Tc. Note that Ta, Tb, Tc may represent clock times, time periods of day, or dates. Which of a clock time, a time period of day, and a date each timing represents can be dependent on demand at what timing is predicted. For example, when the demand prediction model is configured to predict demand in each certain time period of a day, the timings can represent time periods of day. When the demand prediction model is configured to predict demand on each date in a week or in a month, the timings can represent dates.

The suppliable amount determination section 144 determines, based on the predicted demand, an amount of hydrogen that can be supplied (suppliable amount) according to a timing. Specifically, the suppliable amount determination section 144 determines a suppliable amount such that the suppliable amount is larger at a timing when demand is predicted to be higher. The suppliable amount determination section 144 determines a suppliable amount such that the suppliable amount is smaller at a timing when demand is predicted to be lower. In the example in FIG. 11, with respect to the hydrogen station A, the suppliable amount determination section 144 determines a suppliable amount at each timing such that the suppliable amount at the timing corresponding to Ta is larger than the suppliable amount at the timing corresponding to Tb. Similarly, with respect to the hydrogen station A, the suppliable amount determination section 144 determines a suppliable amount at each timing such that the suppliable amount at the timing corresponding to Tc is larger than the suppliable amount at the timing corresponding to Tb.

As described above, the suppliable amount determination section 144 (prediction section 140) determines an amount of hydrogen that can be supplied (suppliable amount) according to a timing, based on the predicted demand, whereby stabilization of revenue at a hydrogen station can be achieved. In other words, by making the suppliable amount larger at a timing when demand is predicted to be higher, opportunity loss, such as a case where a hydrogen station cannot supply hydrogen when a customer visits the hydrogen station to fill a vehicle 2 with hydrogen, can be reduced. Moreover, by making the suppliable amount smaller at a timing when demand is predicted to be lower, loss due to excessive preparation can be reduced. Accordingly, revenue at a hydrogen station can be stabilized.

The suppliable amount determination section 144 may determine, based on the predicted demand for hydrogen, a prepared amount of hydrogen according to a timing of ordering hydrogen. Specifically, the suppliable amount determination section 144 determines, for each hydrogen station, a prepared amount of hydrogen corresponding to demand in a time period according to frequency of ordering. For example, when hydrogen is ordered every week at the hydrogen station A, the suppliable amount determination section 144 determines a prepared amount of hydrogen corresponding to predicted one-week demand for hydrogen for the hydrogen station A. For example, the prepared amount of hydrogen may be determined by adding up predicted amounts of demand at individual timings when demand is predicted in one week. As described above, the suppliable amount determination section 144 (prediction section 140) determines a prepared amount of hydrogen according to a timing of ordering hydrogen, based on the predicted demand for hydrogen, whereby opportunity loss or excessive preparation as described above can be further reduced.

The suppliable amount determination section 144 may determine, based on the predicted demand, a timing when a high-pressure gas of hydrogen is prepared. Specifically, when demand for hydrogen is predicted for each time period of a day, the suppliable amount determination section 144 determines a timing when the high-pressure gas is prepared such that the high-pressure gas (high-pressure hydrogen) is prepared a predetermined time period before (for example, one hour before) a time period during which demand becomes higher. The “predetermined time period” can be set as appropriate, according to a length of time required to make a high-pressure gas of hydrogen. At a hydrogen station, even if hydrogen is prepared, the hydrogen cannot be supplied to a vehicle 2 unless the hydrogen is made to be a high-pressure gas. Accordingly, by determining, based on the predicted demand, a timing when a high-pressure gas of hydrogen is prepared, opportunity loss, such as a case where hydrogen cannot be supplied to a vehicle 2 when a customer visits a hydrogen station, can be reduced.

The notification section 150 notifies a customer at what timing and at which hydrogen station hydrogen can be supplied, according to the predicted demand. The notification section 150 transmits a notification (availability notification) indicating a hydrogen station where hydrogen can be supplied and a timing (time period) when hydrogen can be supplied at the hydrogen station, to a device of a customer via the network 1a by using the interface part 18.

Specifically, the notification section 150 determines, for each hydrogen station, a timing when demand for hydrogen is predicted to occur. For example, the notification section 150 determines, for each hydrogen station, a timing when the amount of demand for hydrogen is predicted to be a predetermined value or more. Then, for each hydrogen station, the notification section 150 sets the timing when demand for hydrogen is predicted to occur, as a timing when hydrogen can be supplied. The notification section 150 generates an availability notification, according to the hydrogen station and the timing. The notification section 150 transmits the generated availability notification.

For example, the notification section 150 may transmit an availability notification to a vehicle 2 of a customer. Thus, the availability notification is displayed in the vehicle 2. In such a case, the notification section 150 may cause the availability notification to be displayed by using a navigation system mounted on the vehicle 2. For example, when a hydrogen station that can supply hydrogen is displayed in a screen of the navigation system, the notification section 150 may cause a timing when hydrogen can be supplied at the hydrogen station to be displayed.

For example, the notification section 150 may transmit an availability notification to a terminal (smartphone or the like) owned by a customer. In such a case, the notification section 150 may perform, on a navigation system that can be implemented by the terminal of the customer, similar processing to the processing performed on the navigation system of the vehicle 2. Alternatively, the notification section 150 may cause a list in which a hydrogen station is associated with a timing when hydrogen can be supplied to be displayed on the terminal.

Alternatively, the notification section 150 may cause an availability notification to be displayed on a website of a hydrogen station. In such a case, the notification section 150 may cause a map to be displayed on the website, and may cause a timing when hydrogen can be supplied at the hydrogen station displayed on the map to be displayed. Alternatively, the notification section 150 may cause a list in which the hydrogen station is associated with a timing when hydrogen can be supplied to be displayed on the website.

The notification section 150 notifies a customer at what timing and at which hydrogen station hydrogen can be supplied according to the predicted demand, whereby customer convenience can be enhanced. Moreover, also on the hydrogen station side, the probability that prepared hydrogen can be supplied is further increased. Accordingly, by making a notification as described above to a customer, demand for and supply of hydrogen can be more reliably adjusted.

When notifying a hydrogen station where hydrogen can be supplied and a timing when hydrogen can be supplied, the notification section 150 may also notify a price of hydrogen. Thus, since a customer can simultaneously find the price of hydrogen and the timing when the vehicle 2 can be filled with hydrogen, customer convenience is enhanced.

The training continuation processing section 160 performs processing for continuing to train the demand prediction model. Specifically, the training continuation processing section 160 acquires an actual result value (an actual amount of demand) corresponding to a predicted value of demand. The training continuation processing section 160 performs the processing for continuing the training by the training section 100 (training continuation processing), depending on the difference between the predicted value of demand and the actual result value. More specifically, the training continuation processing section 160 performs the training continuation processing when the difference between the predicted value of demand and the actual result value is a predetermined threshold value or greater. In other words, a case where the difference between the predicted value of demand and the actual result value is greater is a case where accuracy of demand prediction by the demand prediction model may be deteriorated. Accordingly, in such a case, it is preferable that retraining of the demand prediction model be performed. The threshold value can be determined as appropriate, according to required accuracy of demand.

For example, the training continuation processing can be performed as follows. The training continuation processing section 160 acquires, as input data, customer behavior pattern information (and regional information) up until a time point when the difference between the predicted value of demand and the actual result value becomes the predetermined threshold value or greater. The training continuation processing section 160 acquires, as correct data, actual result values of demand that can be acquired up until the time point. Here, since more time has passed at the time point than at the stage of training the demand prediction model, the data amount of input data acquired at the time point is more than the data amount of input data used at the stage of training the demand prediction model. The training continuation processing section 160 performs the processing such that the demand prediction model is retrained by using pairs of the acquired input data and correct data for training data. Thus, the training section 100 retrains the demand prediction model.

Note that the training continuation processing does not need to be performed immediately at the time point when the difference between the predicted value of demand and the actual result value becomes the predetermined threshold value or greater. For example, the training continuation processing may be performed when the fact that the difference between the predicted value of demand and the actual result value becomes the predetermined threshold value or greater occurs a predetermined number of times or more.

As described above, the information processing device 10 may continue to train the machine learning algorithm, depending on the difference between demand predicted by the prediction section 140 and actual demand With such a configuration, since the demand prediction model is adjusted suitably for actual operation, accuracy of demand prediction can be further enhanced.

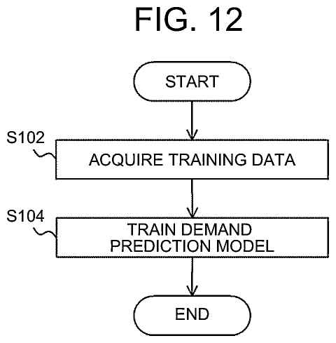

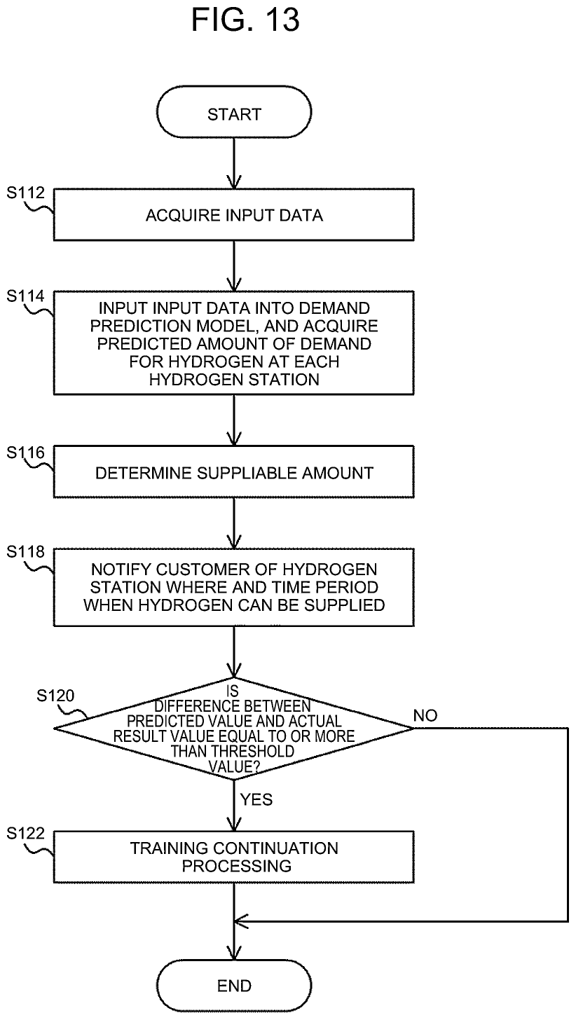

FIGS. 12 and 13 are flowcharts showing an information processing method that is executed by the information processing device 10 according to the first embodiment. The flowcharts shown in FIGS. 12 and 13 correspond to a demand prediction method for predicting demand for hydrogen.

FIG. 12 shows processing at the stage of training the demand prediction model. The training data acquisition section 102 acquires training data that is pairs of input data and correct data, as described above (step S102). The demand prediction model training section 104 performs processing of training the demand prediction model by using the acquired training data, as described above (step S104).

FIG. 13 shows processing at the stage of operating the demand prediction model. The input data acquisition section 124 acquires input data, as described above (step S112). Here, as described above, the input data includes at least a customer behavior pattern (customer behavior pattern information).

The demand prediction section 142 inputs the input data into the demand prediction model that is a trained model, and acquires a predicted amount of demand for hydrogen at each hydrogen station, as described above (step S114). The suppliable amount determination section 144 determines a suppliable amount, based on the predicted demand, as described above (step S116). The notification section 150 notifies a customer of a hydrogen station where and a time period (timing) when hydrogen can be supplied, as described above (step S118).

The training continuation processing section 160 determines whether or not the difference between a predicted value of demand and an actual result value is a predetermined threshold value or greater (step S120). When it is determined that the difference between the predicted value of demand and the actual result value is the predetermined threshold value or greater (YES in S120), the training continuation processing section 160 performs training continuation processing, as described above (step S122). When it is not determined that the difference between the predicted value of demand and the actual result value is the predetermined threshold value or greater (NO in S120), the process in S122 is not performed. Then, the processes in S112 to S122 are repeated.

### Second Embodiment

Next, a second embodiment is described. The second embodiment is different from the first embodiment in a point that a hydrogen price at a hydrogen station is determined according to demand for hydrogen. A configuration of an information processing system 1 according to the second embodiment is substantially similar to the configuration of the information processing system 1 according to the first embodiment shown in FIG. 1, and a description thereof is therefore omitted. Moreover, a hardware configuration of an information processing device 10 according to the second embodiment is substantially similar to the hardware configuration of the information processing device 10 according to the first embodiment shown in FIG. 2, and a description thereof is therefore omitted.

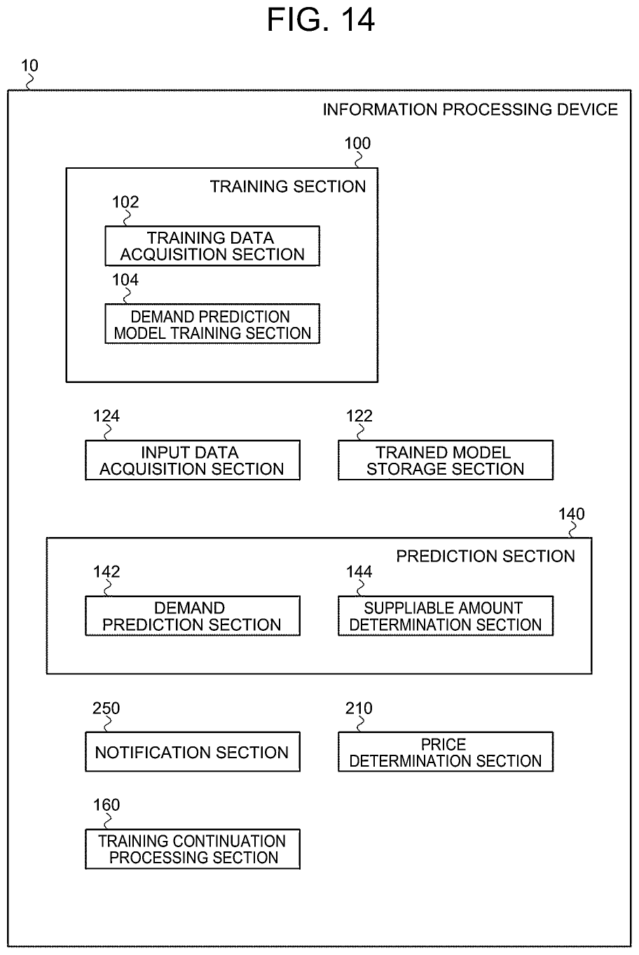

FIG. 14 is a block diagram showing a configuration of the information processing device 10 according to the second embodiment. The information processing device 10 according to the second embodiment includes constituent elements that are substantially the same as the constituent elements of the information processing device 10 according to the first embodiment shown in FIG. 3. Moreover, the information processing device 10 according to the second embodiment includes a price determination section 210 (determination section) and a notification section 250. In the information processing device 10 according to the second embodiment, functions of the same constituent elements as the constituent elements of the information processing device 10 shown in FIG. 3 are substantially similar to the functions according to the first embodiment unless otherwise specified, and a description thereof is therefore omitted as appropriate.

The prediction section 140 predicts time-series demand for hydrogen at a hydrogen station as described above. In other words, the prediction section 140 predicts changes over time in demand for hydrogen at a hydrogen station. The prediction section 140 can predict at least changes over time in demand for hydrogen at the hydrogen station on one day after a predetermined time period (for example, after one week or after one month).

For each hydrogen station, the price determination section 210 determines prices of hydrogen (hydrogen prices), based on the demand for hydrogen predicted by the prediction section 140. In other words, the price determination section 210 determines hydrogen prices for each hydrogen station, depending on the predicted time-series amounts of demand for hydrogen. Specifically, the price determination section 210 determines hydrogen prices at a hydrogen station such that the hydrogen price is higher in a time period when the predicted amount of demand for hydrogen is larger. Moreover, the price determination section 210 determines a hydrogen price a predetermined time period (for example, one week or one month) after a current time point.

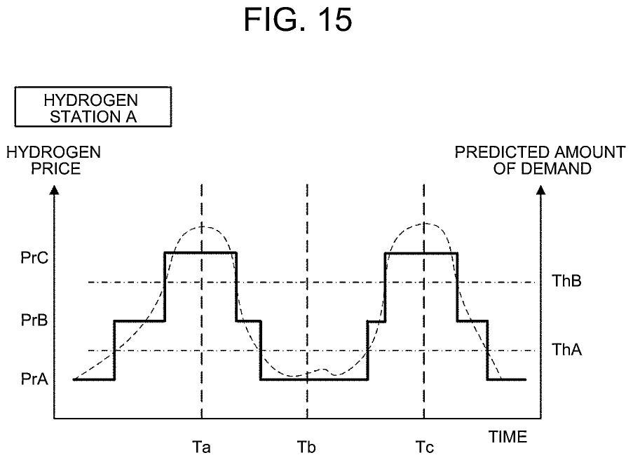

FIG. 15 is a diagram for describing an example of a price determination method by the price determination section 210 according to the second embodiment. FIG. 15 illustrates the method for determining hydrogen prices according to the demand predictions illustrated in FIG. 11. FIG. 15 illustrates a relationship between the predicted amount of demand for hydrogen and the hydrogen price at the hydrogen station A. In FIG. 15, the predicted amount of demand is indicated by a thin broken line. In FIG. 15, the hydrogen price is indicated by a thick solid line. With respect to the predicted amount of demand, two threshold values ThA, ThB are preset. Here, ThA<ThB. Moreover, three hydrogen prices PrA, PrB, PrC are preset. Here, PrA<PrB<PrC.

The price determination section 210 determines that the hydrogen price is PrA, which is the lowest hydrogen price, in a time period when the predicted amount of demand is less than the threshold value ThA. The price determination section 210 determines that the hydrogen price is second lowest PrB in a time period when the predicted amount of demand is equal to or more than the threshold value ThA and is equal to or less than the threshold value ThB. The price determination section 210 determines that the hydrogen price is PrC, which is the highest hydrogen price, in a time period when the predicted amount of demand is more than the threshold value ThB. Thus, the hydrogen price is high at timings corresponding to Ta, Tc when the predicted amount of demand is large, and the hydrogen price is low at a timing corresponding to Tb when the predicted amount of demand is small.

Note that although the number of threshold values of the predicted amount of demand is two and the number of hydrogen prices is three in the example in FIG. 15, such a configuration does not impose limitations. The number of hydrogen prices may be arbitrarily set, and the number of threshold values of the predicted amount of demand can be set as appropriate, depending on the number of hydrogen prices. Moreover, although the hydrogen price changes in a stepwise, discontinuous manner according to the predicted amount of demand in the example in FIG. 15, such a configuration does not impose a limitation. The price determination section 210 may determine hydrogen prices such that the hydrogen price changes in a continuous manner according to the predicted amount of demand. In other words, the price determination section 210 may determine hydrogen prices such that the hydrogen price continuously increases as the predicted amount of demand increases, and the hydrogen price continuously decreases as the predicted amount of demand decreases. In such a case, the relationship between the predicted amount of demand and the hydrogen price may be determined by a predetermined function.

The price determination section 210 may update the method for determining hydrogen prices each time such that revenue is increased (maximized). For example, the price determination section 210 may update the method for determining hydrogen prices according to the predicted amount of demand such that revenue is increased (maximized), through machine learning such as a reinforcement learning algorithm. For example, the price determination section 210 may update the set values of the hydrogen price (PrA and the like) and the threshold values of the predicted amount of demand (ThA and the like) through the reinforcement learning algorithm or the like. The price determination section 210 may update the function representing the relationship between the predicted amount of demand and the hydrogen price through the reinforcement learning algorithm or the like. The same holds true also for other embodiments that are described below.

With such a configuration, the information processing device 10 according to the second embodiment can adjust the hydrogen price at each hydrogen station according to demand for hydrogen. Here, in general, demand for a product tends to decrease as the price of the product increases, and demand for a product tends to increase as the price of the product decreases. Accordingly, by adjusting the hydrogen price according to demand for hydrogen, equalization of demand for hydrogen at a hydrogen station can be achieved. In other words, demand for hydrogen at a hydrogen station can be adjusted. Thus, the difference between business volume during a slack period and business volume during a busy period can be made smaller. Accordingly, operation of a hydrogen station can be efficiently performed. Accordingly, benefit (merit) enjoyed by the hydrogen station can be efficiently increased.

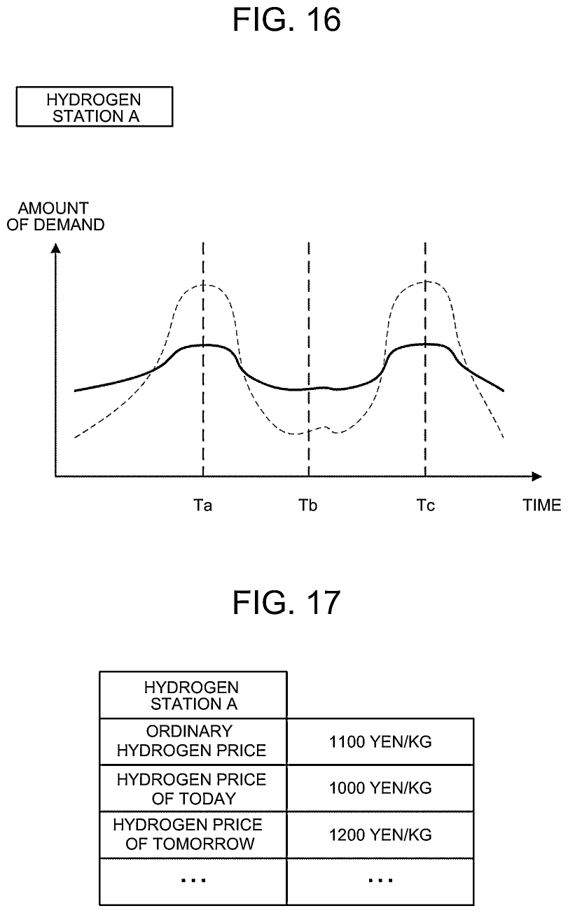

FIG. 16 illustrates actual demand for hydrogen when hydrogen prices are determined by the price determination section 210 according to the second embodiment. In FIG. 16, predicted amounts of demand are indicated by a thin broken line. In FIG. 16, actual amounts of demand are indicated by a thick solid line. The predicted amounts of demand correspond to the predicted amounts of demand shown in FIGS. 11 and 15. The hydrogen price is higher at a timing when the predicted amount of demand is larger and the hydrogen price is lower at a timing when the predicted amount of demand is smaller as illustrated in FIG. 15, whereby fluctuations of the actual amounts of demand are smaller than fluctuations of the predicted amounts of demand as illustrated in FIG. 16. In other words, hydrogen prices are determined by the price determination section 210, whereby demand for hydrogen at a hydrogen station is equalized.

The information processing device 10 according to the second embodiment can increase revenue at a hydrogen station by setting the hydrogen price higher when the predicted amount of demand is larger at the hydrogen station. When the predicted amount of demand at a hydrogen station is smaller, demand at the timing can be increased by setting the hydrogen price lower. Accordingly, benefit (merit) enjoyed by the hydrogen station can be efficiently increased.

The notification section 250 notifies the hydrogen prices determined by the price determination section 210 to a customer. The notification section 250 transmits a notification (hydrogen price notification) indicating the hydrogen prices at a hydrogen station to a device of the customer via the network 1a by using the interface part 18.

FIG. 17 illustrates the hydrogen price notification according to the second embodiment. FIG. 17 illustrates the hydrogen price notification related to the hydrogen station A. The hydrogen price notification illustrated in FIG. 17 includes “ordinary hydrogen price”, “hydrogen price of today”, and “hydrogen price of tomorrow”. By notifying hydrogen prices of a plurality of days as described above, a customer can determine on which day the customer visits the hydrogen station, based on the hydrogen prices, a time convenient to the customer, and the like. The customer can visit the hydrogen station, in particular, on a day when the hydrogen price is low. Accordingly, customer convenience can be enhanced.

For example, the notification section 250 may transmit the hydrogen price notification to a vehicle 2 of the customer. Thus, the hydrogen price notification is displayed in the vehicle 2. In such a case, the notification section 250 may cause the hydrogen prices to be displayed by using a navigation system mounted on the vehicle 2. For example, the notification section 250 may cause hydrogen prices related to a hydrogen station displayed in a screen of the navigation system to be displayed.

For example, the notification section 250 may transmit the hydrogen price notification to a terminal (smartphone or the like) owned by the customer. In such a case, the notification section 250 may perform, on a navigation system that can be implemented by the terminal of the customer, processing similar to the processing performed on the navigation system of the vehicle 2.

Alternatively, the notification section 250 may cause the hydrogen price notification to be displayed on a website of the hydrogen station. In such a case, the notification section 250 may cause a map to be displayed on the website, and may cause the hydrogen prices at the hydrogen station displayed on the map to be displayed. Alternatively, the notification section 250 may cause a list in which the hydrogen station is associated with the hydrogen prices to be displayed on the website.

For example, the notification section 250 may notify hydrogen prices at a hydrogen station that is frequently visited by a customer to the customer. In such a case, the notification section 250 may determine frequency of visits made by the customer by using the customer behavior pattern information. For example, the notification section 250 may notify hydrogen prices at a hydrogen station that is pre-registered for each customer to the customer. For example, when the customer #1 registers the hydrogen station A with the system, the notification section 250 may notify the hydrogen prices at the hydrogen station A to the customer #1.

The notification section 250 may notify a hydrogen price at a timing required for each customer. For example, when the hydrogen price is changed at a hydrogen station in the neighborhood of a customer, the notification section 250 may notify a hydrogen price at the hydrogen station to the customer. For example, when the hydrogen price is changed at a hydrogen station pre-registered by a customer, the notification section 250 may notify a hydrogen price at the hydrogen station to the customer. The notification section 250 may notify a hydrogen price at a hydrogen station to a customer whose vehicle 2 has a small remaining amount of hydrogen.

The notification section 250 notifies determined hydrogen prices to a customer, whereby customer convenience can be enhanced. A customer visits a hydrogen station particularly when the hydrogen price is lower, whereby a cost for purchasing hydrogen can be reduced. Moreover, the notification section 250 notifies a hydrogen price at a timing required for each customer, whereby customer convenience can be further enhanced. Furthermore, also on the hydrogen station side, equalization of demand for hydrogen can be more reliably achieved.

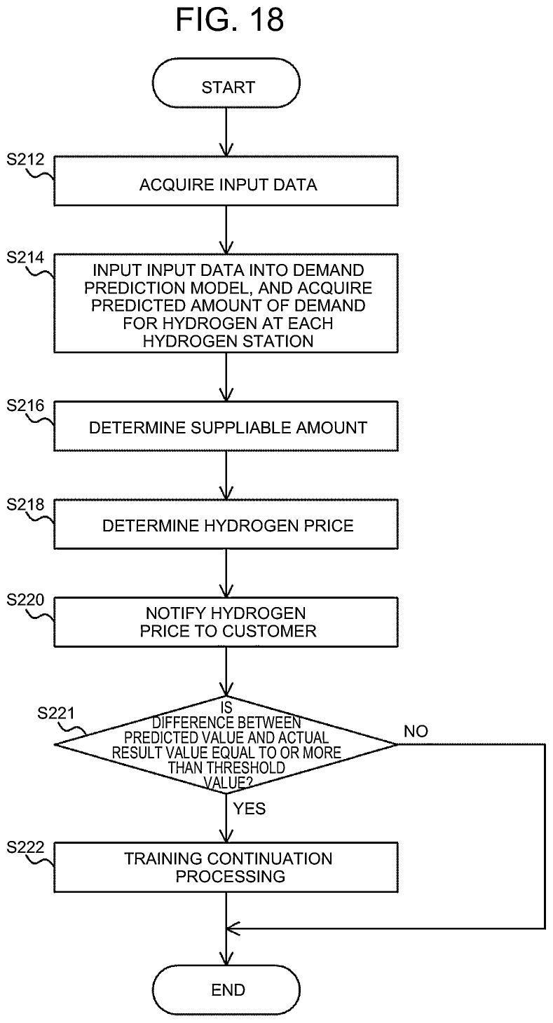

FIG. 18 is a flowchart showing an information processing method that is executed by the information processing device 10 according to the second embodiment. The flowchart shown in FIG. 18 corresponds to a price determination method for determining a hydrogen price at a hydrogen station. The input data acquisition section 124 acquires input data, as in S112 in FIG. 13 (step S212). The demand prediction section 142 inputs the input data into the demand prediction model that is a trained model, and acquires a predicted amount of demand for hydrogen at each hydrogen station, as in S114 in FIG. 13 (step S214). The suppliable amount determination section 144 determines a suppliable amount based on the predicted demand, as in S114 in FIG. 13 (step S216).

The price determination section 210 determines a hydrogen price at a hydrogen station according to the predicted demand for hydrogen, as described above (step S218). Specifically, the price determination section 210 determines a hydrogen price such that the hydrogen price is higher at a timing when the predicted amount of demand is larger. The notification section 250 notifies the hydrogen price at the hydrogen station to a customer, as described above (step S220).

The training continuation processing section 160 determines whether or not the difference between a predicted value of demand and an actual result value is a predetermined threshold value or greater, as in S120 in FIG. 13 (step S221). When it is determined that the difference between the predicted value of demand and the actual result value is the predetermined threshold value or greater (YES in S221), the training continuation processing section 160 performs training continuation processing, as in S122 in FIG. 13 (step S222). When it is not determined that the difference between the predicted value of demand and the actual result value is the predetermined threshold value or greater (NO in S221), the process in S222 is not performed. As described above, since demand for hydrogen changing according to a determined hydrogen price can be predicted, accuracy of prediction of demand for hydrogen can be further enhanced. Then, the processes in S212 to S222 can be repeated.

### Third Embodiment

Next, a third embodiment is described. The third embodiment is different from the other embodiments in a point that a demand prediction model that receives a hydrogen price at a hydrogen station as input is used when a hydrogen price at the hydrogen station is determined. A configuration of an information processing system 1 according to the third embodiment is substantially similar to the configuration of the information processing system 1 according to the first embodiment shown in FIG. 1, and a description thereof is therefore omitted. A hardware configuration of an information processing device 10 according to the third embodiment is substantially similar to the hardware configuration of the information processing device 10 according to the first embodiment shown in FIG. 2, and a description thereof is therefore omitted.

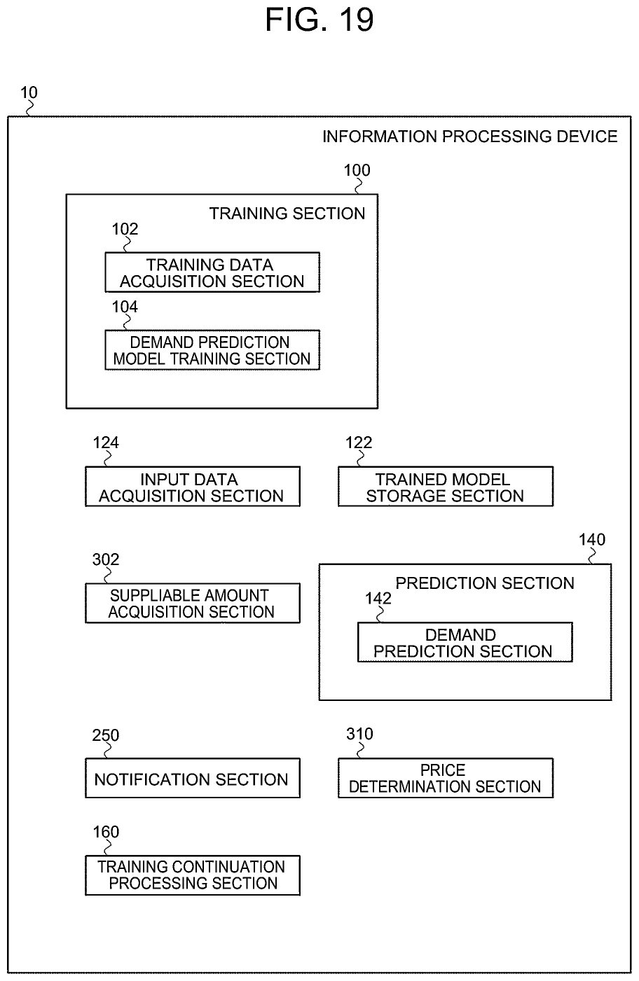

FIG. 19 is a block diagram showing a configuration of the information processing device 10 according to the third embodiment. As in the first embodiment and the like, the information processing device 10 according to the third embodiment includes a training section 100, a trained model storage section 122, an input data acquisition section 124, a prediction section 140, and a training continuation processing section 160. Here, the prediction section 140 includes a demand prediction section 142, but does not need to include a suppliable amount determination section 144. Moreover, the information processing device 10 according to the third embodiment includes a suppliable amount acquisition section 302, a price determination section 310 (determination section), and a notification section 250.

Functions of the same constituent elements as the constituent elements of the information processing device 10 shown in FIG. 3 are substantially similar to the functions according to the first embodiment unless otherwise specified, and a description thereof is therefore omitted as appropriate. A function of the notification section 250 is substantially similar to the function according to the second embodiment unless otherwise specified, and a description thereof is therefore omitted as appropriate.

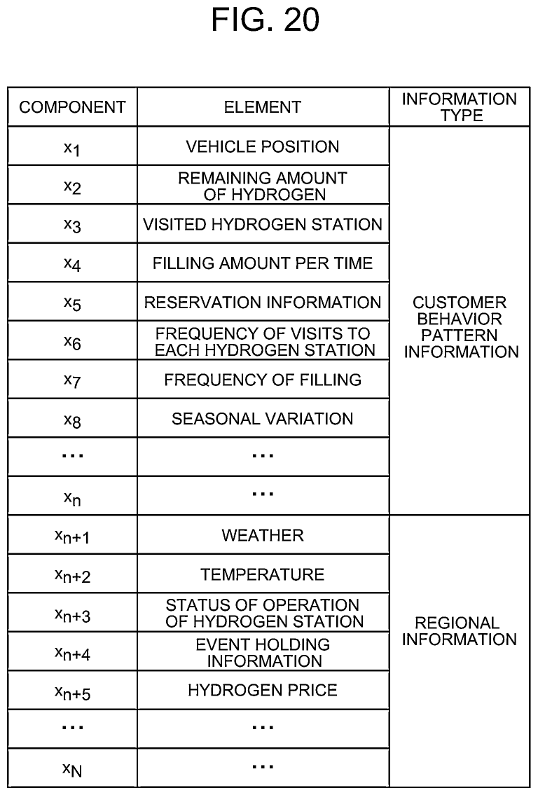

FIG. 20 illustrates features in input data according to the third embodiment. Customer behavior pattern information may be substantially similar to the customer behavior pattern information according to the first embodiment. Regarding the features included in regional information, a component xₙ₊₅ indicates a hydrogen price at a hydrogen station in a corresponding region. In the input data, the hydrogen price can be arbitrarily set. As described above, the demand prediction model receives a hydrogen price at a hydrogen station as input in the third embodiment. The training section 100 performs such training of the demand prediction model that includes a hydrogen price at a hydrogen station as input data. Accordingly, the demand prediction model according to the third embodiment can predict lower demand when the hydrogen price in the input data is higher, and can predict higher demand when the hydrogen price in the input data is lower.

The suppliable amount acquisition section 302 acquires a suppliable amount. In other words, in the third embodiment, the suppliable amount is not determined according to the predicted amount of demand, but is configured to be preset. In other words, the suppliable amount is not necessarily always able to be determined according to the predicted amount of demand. For example, there are some cases where the suppliable amount is preset based on an agreement between a hydrogen station and a wholesaler that provides hydrogen to the hydrogen station.

The price determination section 310 determines a hydrogen price, according to a hydrogen price input into the demand prediction model and a predicted amount of demand obtained by using the demand prediction model. At the time, the price determination section 310 determines the hydrogen price such that revenue at the hydrogen station is increased (maximized). Moreover, the price determination section 310 determines a hydrogen price a predetermined time period (for example, one week or one month) after a current time point. Details will be described later.

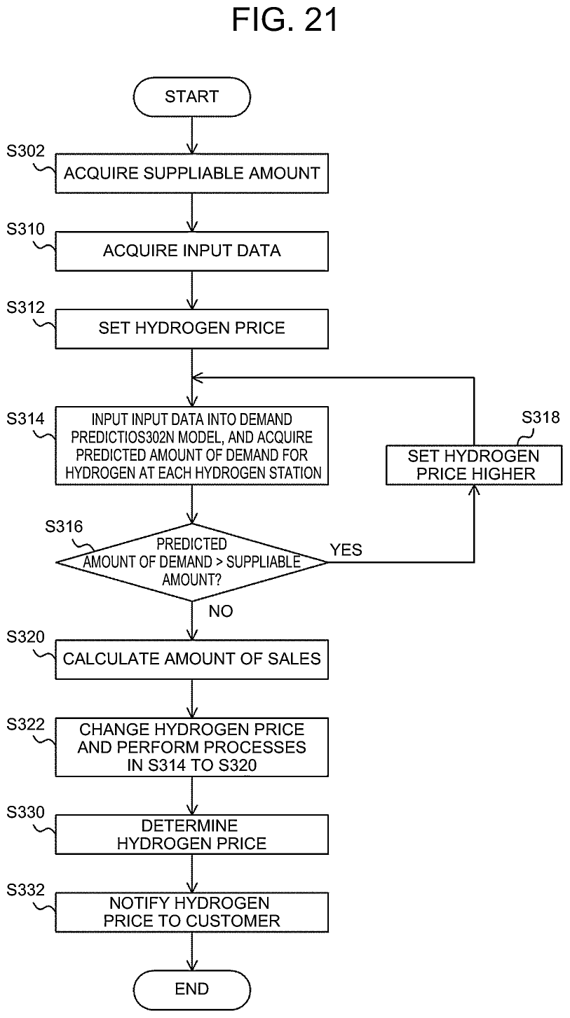

FIG. 21 is a flowchart showing an information processing method that is executed by the information processing device 10 according to the third embodiment. The flowchart shown in FIG. 21 corresponds to a price determination method for determining a hydrogen price at a hydrogen station. The flowchart shown in FIG. 21 can be executed for each hydrogen station. The suppliable amount acquisition section 302 acquires a suppliable amount (step S302). The input data acquisition section 124 acquires input data, as in S112 in FIG. 13 (step S310). Here, a hydrogen price does not need to be set in the input data acquired in S310. The price determination section 310 sets a hydrogen price in the input data (step S312).

The demand prediction section 142 inputs the input data into the demand prediction model that is a trained model, and acquires an amount of demand for hydrogen predicted (predicted amount of demand) for each hydrogen station, as in S114 in FIG. 13 (step S314). The price determination section 310 determines whether or not the predicted amount of demand acquired in S314 is more than the suppliable amount acquired in S302 (step S316). When the predicted amount of demand is more than the suppliable amount (YES in S316), the predicted amount of demand is too large compared to the suppliable amount because the hydrogen price is set too low. Accordingly, in such a case, the price determination section 310 sets the hydrogen price higher than the hydrogen price set in S312 (step S318). Then, the processes in S314 and S316 are performed again. As to how high the hydrogen price is set, an arbitrary method may be used. For example, the hydrogen price may be set higher by a predetermined price (for example, 5 yen/kg) than the hydrogen price set in S312.

When the predicted amount of demand is equal to or less than the suppliable amount (NO in S316), the price determination section 310 calculates the then amount of sales (step S320). Specifically, the price determination section 310 calculates the amount of sales of hydrogen at a corresponding hydrogen station by multiplying the set hydrogen price by the predicted amount of demand.

Next, the price determination section 310 changes the hydrogen price and performs the processes in S314 to S320 (step S322). Specifically, the price determination section 310 repeats the processes in S314 to S320 until the processing is finished with respect to hydrogen prices that can be set. Thus, the amount of sales is calculated with respect to each of the hydrogen prices that can be set. Note that when the hydrogen price is changed in the process in S322, change to a hydrogen price set when YES is determined in the process in S316 may be avoided.

Next, the price determination section 310 determines a hydrogen price, based on the calculated amount of sales (step S330). Specifically, the price determination section 310 may determine a hydrogen price that maximizes the amount of sales, as the hydrogen price at the hydrogen station. Alternatively, the price determination section 310 may determine a hydrogen price that maximizes a value obtained by subtracting a purchase price (cost) for the suppliable amount from the amount of sales, as the hydrogen price at the hydrogen station. Thus, such a hydrogen price that maximizes revenue (benefit) at the hydrogen station is determined.

The notification section 250 notifies the hydrogen price at the hydrogen station to a customer, as described above (step S332). Note that the information processing device 10 according to the third embodiment may perform training continuation processing (S122 in FIG. 13). Although the hydrogen price is set higher when the predicted amount of demand is more than the suppliable amount (YES in S316, S318) in the above-described example, such a configuration does not impose a limitation. The processes in S316 and S318 do not need to be performed. In such a case, the process in S302 does not need to be performed.

As described above, the information processing device 10 according to the third embodiment is configured to determine a hydrogen price, according to a hydrogen price input into the demand prediction model and a predicted amount of demand acquired by using the demand prediction model. Thus, the information processing device 10 according to the third embodiment can determine such a hydrogen price that maximizes revenue at a hydrogen station. Accordingly, an increase in revenue can be more reliably achieved.

### Fourth Embodiment

Next, a fourth embodiment is described. The fourth embodiment is different from the other embodiments in a point that when a hydrogen price at a hydrogen station is determined, the hydrogen price is determined according to a predicted amount of demand and a suppliable amount. A configuration of an information processing system 1 according to the fourth embodiment is substantially similar to the configuration of the information processing system 1 according to the first embodiment shown in FIG. 1, and a description thereof is therefore omitted. A hardware configuration of an information processing device 10 according to the fourth embodiment is substantially similar to the hardware configuration of the information processing device 10 according to the first embodiment shown in FIG. 2, and a description thereof is therefore omitted.

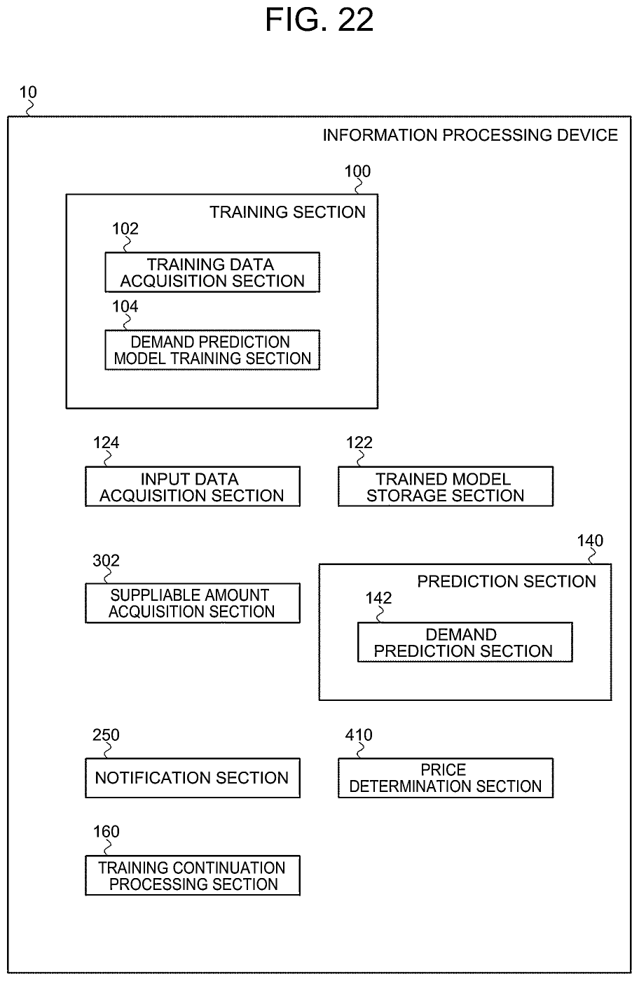

FIG. 22 is a block diagram showing a configuration of the information processing device 10 according to the fourth embodiment. As in the third embodiment, the information processing device 10 according to the fourth embodiment includes a training section 100, a trained model storage section 122, an input data acquisition section 124, a prediction section 140, and a training continuation processing section 160. Here, the prediction section 140 includes a demand prediction section 142, but does not need to include a suppliable amount determination section 144. Moreover, the information processing device 10 according to the fourth embodiment includes a suppliable amount acquisition section 302, a price determination section 410 (determination section), and a notification section 250.

Functions of the same constituent elements as the constituent elements of the information processing device 10 shown in FIG. 3 are substantially similar to the functions according to the first embodiment unless otherwise specified, and a description thereof is therefore omitted as appropriate. Functions of the suppliable amount acquisition section 302 and the notification section 250 are substantially similar to the functions according to the third embodiment and the second embodiment, respectively, unless otherwise specified, and a description thereof is therefore omitted as appropriate.

The price determination section 410 determines a hydrogen price, based on a ratio between a predicted amount of demand and a suppliable amount at a certain timing at a hydrogen station. Specifically, the price determination section 410 determines a hydrogen price, based on a hydrogen demand ratio (first ratio) that is a ratio of the predicted amount of demand to the suppliable amount. With such a configuration, demand for hydrogen and the hydrogen price can be adjusted according to a purpose on the hydrogen station side (revenue increase, demand promotion, demand restraint, or the like), based on the predicted amount of demand and the suppliable amount, as will be described later. In other words, benefit (revenue increase, demand promotion, demand restraint, or the like) on the hydrogen station side according to the predicted amount of demand and the suppliable amount can be more reliably increased.

More specifically, when the hydrogen demand ratio is equal to or more than a first threshold value and is equal to or less than a second threshold value that is greater than the first threshold value, the price determination section 410 determines a price of hydrogen such that the price becomes higher as the hydrogen demand ratio becomes larger. At the time, the price determination section 410 determines the price of hydrogen such that the price becomes higher as the hydrogen demand ratio becomes larger, between a first price and a second price. Details will be described later. Note that the first threshold value, the second threshold value, the first price, and the second price are predetermined values. The predetermined values may be updated as appropriate through machine learning such as a reinforcement learning algorithm.

When the hydrogen demand ratio (first ratio) is less than the first threshold value, the price determination section 410 may determine a price of hydrogen such that the price is lower than the first price. When the hydrogen demand ratio (first ratio) is more than the second threshold value, the price determination section 410 may determine a price of hydrogen such that the price is higher than the second price. Details will be described later.

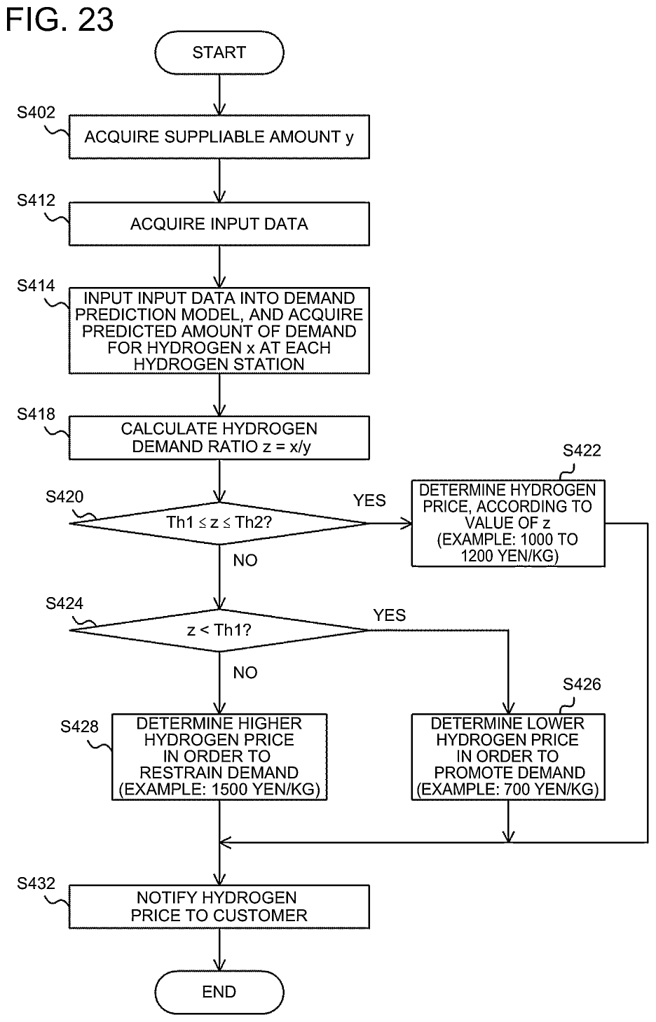

FIG. 23 is a flowchart showing an information processing method that is executed by the information processing device 10 according to the fourth embodiment. The flowchart shown in FIG. 23 corresponds to a price determination method for determining a hydrogen price at a hydrogen station. The flowchart shown in FIG. 23 can be executed for each hydrogen station. The suppliable amount acquisition section 302 acquires a suppliable amount y (step S402). The input data acquisition section 124 acquires input data, as in S112 in FIG. 13 (step S412). The demand prediction section 142 inputs the input data into the demand prediction model that is a trained model, and acquires a predicted amount of demand for hydrogen x at each hydrogen station, as in S114 in FIG. 13 (step S414).

The price determination section 410 calculates a hydrogen demand ratio (first ratio) (step S418). Specifically, the price determination section 410 calculates the hydrogen demand ratio z by dividing the amount of demand for hydrogen x by the suppliable amount y. In other words, z=x/y.

The price determination section 410 determines whether or not the hydrogen demand ratio z is equal to or more than a threshold value Th1 (first threshold value) and is equal to or less than a threshold value Th2 (second threshold value) (step S420). The threshold value Th1 is a predetermined value that is less than one. For example, Th1=0.15. The threshold value Th2 is a predetermined value that is greater than the threshold value Th1. For example, Th2=0.9. In other words, the price determination section 410 determines whether or not the ratio of the amount of demand for hydrogen x to the suppliable amount y (hydrogen demand ratio) is equal to or more than 15% and is equal to or less than 90%.

When the hydrogen demand ratio z is equal to or more than the threshold value Th1 and is equal to or less than the threshold value Th2 (YES in S420), the price determination section 410 determines a hydrogen price, according to the value of the hydrogen demand ratio z (step S422). Specifically, the price determination section 410 determines a price of hydrogen such that the price becomes higher as the hydrogen demand ratio z becomes larger.

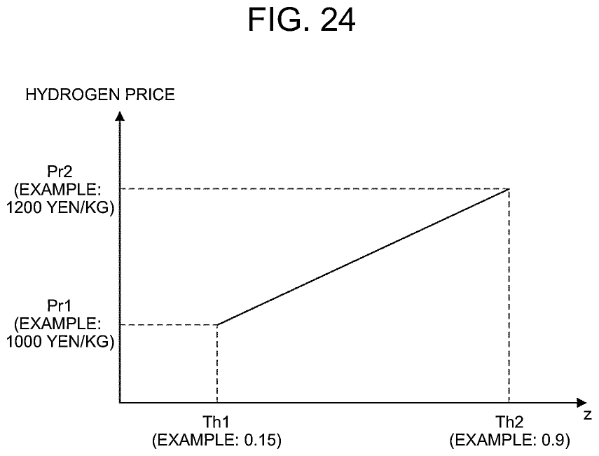

FIG. 24 is a diagram for describing the price determination method by the price determination section 410 according to the fourth embodiment. FIG. 24 illustrates a relationship between the hydrogen demand ratio z and the hydrogen price. In the example in FIG. 24, when the hydrogen demand ratio z is equal to or more than the threshold value Th1 and is equal to or less than the threshold value Th2, the price determination section 410 determines a price of hydrogen such that the price becomes higher as the hydrogen demand ratio z becomes larger, between a price Pr1 (first price) and a price Pr2 (second price). Note that Pr1 and Pr2 are predetermined values, and Pr1<Pr2. For example, Pr1=1000 yen/kg, and Pr2=1200 yen/kg. In the example in FIG. 24, when the hydrogen demand ratio z=0.15, the price determination section 410 determines that the hydrogen price is 1000 yen/kg. When the hydrogen demand ratio z=0.9, the price determination section 410 determines that the hydrogen price is 1200 yen/kg. A price of hydrogen is determined such that the price become higher as the hydrogen demand ratio z becomes larger as described above, whereby an increase in revenue can be achieved according to the predicted amount of demand and the suppliable amount.

Note that although the relationship between the hydrogen demand ratio z and the hydrogen price is linear in the example in FIG. 24, the relationship between the hydrogen demand ratio z and the hydrogen price does not need to be linear. The hydrogen price may increase in a discontinuous, stepwise manner as the hydrogen demand ratio z becomes larger. The hydrogen price may exponentially increase as the hydrogen demand ratio z becomes larger. The hydrogen price may logarithmically increase as the hydrogen demand ratio z becomes larger.

When the hydrogen demand ratio z is not equal to or more than the threshold value Th1 and is not equal to or less than the threshold value Th2 (NO in S420), the price determination section 410 determines whether or not the hydrogen demand ratio z is less than the threshold value Th1 (first threshold value) (step S424). In other words, the price determination section 410 determines whether or not the ratio of the amount of demand for hydrogen x to the suppliable amount y (hydrogen demand ratio) is less than 15%.

When the hydrogen demand ratio z is less than the threshold value Th1 (YES in S424), it can be said that the predicted amount of demand x is too small compared to the suppliable amount y. In other words, the current state, if unchanged, may lead to an oversupply of hydrogen, and an excessive amount of hydrogen may remain unsold. Accordingly, in such a case, the price determination section 410 sets the hydrogen price lower in order to promote demand (step S426). Specifically, the price determination section 410 determines that the hydrogen price is a price lower than Pr1. For example, the price determination section 410 determines that the hydrogen price is 700 yen/kg. Thus, demand for hydrogen can be promoted when the predicted amount of demand x is too small compared to the suppliable amount y.

When the hydrogen demand ratio z is not less than the threshold value Th1 (NO in S424), the hydrogen demand ratio z is more than the threshold value Th2. In other words, the ratio of the amount of demand for hydrogen x to the suppliable amount y (hydrogen demand ratio) is more than 90%. In such a case, it can be said that the predicted amount of demand x is too large compared to the suppliable amount y. In other words, the current state, if unchanged, may lead to a shortage of supply. Accordingly, in such a case, the price determination section 410 sets the hydrogen price higher in order to restrain demand (step S428). Specifically, the price determination section 410 determines that the hydrogen price is a price higher than Pr2. For example, the price determination section 410 determines that the hydrogen price is 1500 yen/kg. Thus, demand for hydrogen can be restrained when the predicted amount of demand x is too large compared to the suppliable amount y.

The notification section 250 notifies the hydrogen price at the hydrogen station to a customer, as described above (step S432). Note that the information processing device 10 according to the fourth embodiment may perform training continuation processing (S122 in FIG. 13).

Modification

The disclosure is not limited to the embodiments, and changes can be made as appropriate within a scope that does not depart from the principle of the disclosure. For example, order of the plurality of steps in the flowcharts can be changed as appropriate. One or more steps in the flowcharts can be omitted as appropriate. For example, the processes in S216 and S220 to S222 in FIG. 18 may be omitted. With respect to FIGS. 21 and 23, the processes in S332 and S432, respectively, can be omitted.

A program includes instructions (or software codes) for causing a computer to perform one or more of the functions described in the embodiments when the program is read by the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD), any other memory technology, a CD-ROM, a digital versatile disk (DVD), Blu-ray® Disc, any other optical disk storage, a magnetic cassette, a magnetic tape, a magnetic disk storage, and any other magnetic storage device. The program may be transmitted over a transitory computer-readable medium or a communication medium. Examples of the transitory computer-readable medium or the communication medium include, but are not limited to, electric, optical, acoustic, and any other form of propagation signals.

What is claimed is:

1. An information processing device comprising:
a prediction section that predicts demand for hydrogen at a hydrogen station by using a demand prediction model that is a trained model generated beforehand through machine learning, the demand prediction model receiving at least a behavior pattern of a customer as input and outputting predicted demand for hydrogen; and
a determination section that determines a price of hydrogen at the hydrogen station, based on the predicted demand for hydrogen.

2. The information processing device according to claim 1, wherein the determination section determines the price of hydrogen, based on a ratio between a predicted amount of demand that is the predicted demand for hydrogen at a certain timing at the hydrogen station and a suppliable amount that is an amount of hydrogen suppliable at the certain timing at the hydrogen station.

3. The information processing device according to claim 2, wherein when a first ratio that is a ratio of the predicted amount of demand to the suppliable amount is equal to or more than a predetermined first threshold value and is equal to or less than a predetermined second threshold value that is greater than the first threshold value, the determination section determines the price of hydrogen such that the price becomes higher as the first ratio becomes larger, between a predetermined first price and a predetermined second price.

4. The information processing device according to claim 3, wherein when the first ratio is less than the first threshold value, the determination section determines the price of hydrogen such that the price is lower than the first price.

5. The information processing device according to claim 3, wherein when the first ratio is more than the second threshold value, the determination section determines the price of hydrogen such that the price is higher than the second price.

6. The information processing device according to claim 1, wherein
the demand prediction model receives the behavior pattern and a price of hydrogen at the hydrogen station as input, and
the determination section determines the price of hydrogen, according to the price of hydrogen input into the demand prediction model and a predicted amount of demand that is the demand for hydrogen acquired by using the demand prediction model.

7. The information processing device according to claim 1, further comprising a notification section that notifies the determined price of hydrogen to the customer.

8. The information processing device according to claim 1, further comprising a training section that trains the demand prediction model through machine learning,
wherein the training section continues to train the demand prediction model, depending on a difference between the demand predicted by the prediction section and actual demand.

9. An information processing method comprising:
predicting demand for hydrogen at a hydrogen station by using a demand prediction model that is a trained model generated beforehand through machine learning, the demand prediction model receiving at least a behavior pattern of a customer as input and outputting predicted demand for hydrogen; and
determining a price of hydrogen at the hydrogen station, based on the predicted demand for hydrogen.

10. A non-transitory storage medium that stores a program causing a computer to execute the steps of:
predicting demand for hydrogen at a hydrogen station by using a demand prediction model that is a trained model generated beforehand through machine learning, the demand prediction model receiving at least a behavior pattern of a customer as input and outputting predicted demand for hydrogen; and
determining a price of hydrogen at the hydrogen station, based on the predicted demand for hydrogen.
